(19) United States
(12) Patent Application Publication
(10) Pub. No.: US 2009/0015912 A1
(43) Pub. Date: Jan. 15, 2009

(54) Total Internal Reflectance Fluorescence (TIRF) Microscope

(75) Inventor: Michael Alan Ferenczi, London (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Imperial Inovations Limited, London (GB)

(21) Appl. No.: 11/718,546

(22) PCT Filed: Nov. 8, 2005
(86) PCT No.: PCT/GB05/04314

§ 371 Date: Apr. 29, 2008

(30) Foreign Application Priority Data
Nov. 8, 2004 (GB) 0424652.6

(51) Int. Cl. G02B 21/06

(52) U.S. Cl. 359/385

(57) ABSTRACT

A total internal reflection fluorescent (TIRF) microscope has a conjugate lens (30) which is positioned off of the primary microscope axis (AA). The lens (30) is held by a mount (60) allowing the radial spacing between the microscope axis (AA) and the conjugate lens axis (BB) to be varied. The mount (60) also allows the lens to be rotated around the microscope axis. As the lens (30) rotates, the spot of light (64) created by the incident laser beam moves around the periphery of the objective lens (34). This changes the direction of polarisation of the evanescent wave within which the sample (44) sits. By studying the emitted fluorescence as a function of lens angle, information is provided about the spatial attitude of a molecule under study.

The present invention relates to a total internal reflectance microscope, and preferably to a total internal reflectance fluorescence (TIRF) microscope.

TIRF microscopy has become increasingly popular in recent years, particularly as a tool to investigate the way in which macro molecules enzymes, proteins and so on move in real time. Typically, one or more probes are attached to a protein or other molecule to be studied, in a defined orientation. Then, as the molecule moves, for example as it undergoes catalysis, the changes in probe orientation are detected. Most probes are fluorescent, and have a natural dipole. Light having a direction of polarisation which is parallel to the dipole is preferentially absorbed; similarly, fluorescent light emitted by the probe is also preferentially polarised in a direction parallel to the dipole axis.

In a typical TIRF microscope, a sample to be studied is illuminated with plane polarised laser light of a suitable wavelength for absorption by the probes. This causes the probes to fluoresce (typically at a different wavelength), and the emitted light broken down into two perpendicular polarisation components. By studying the ratio of these, the anisotropy can be determined.

In a TIRF microscope, the effective depth of field is kept very small by positioning the molecule to be studied very close to a glass or other surface and then shining light through the glass at a glancing angle so as to obtain total internal reflectance at the internal surface adjacent the sample. At the point at which total internal reflectance occurs, an evanescent wave is generated which extends outward from the glass surface for perhaps 200 nm or so. The sample is positioned within this evanescent wave and the polarised evanescent wave stimulates the fluorescent probes to emit, the emitted light then being detected and analysed as previously mentioned.

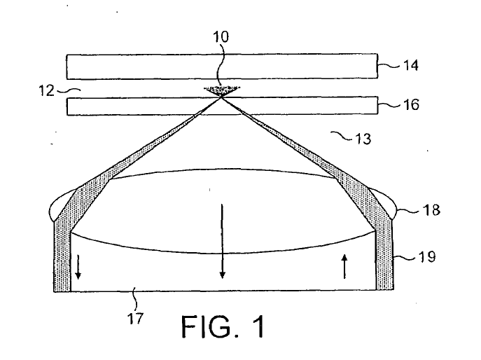

A typical TIRF arrangement is shown schematically in FIG. 1. A sample 10 to be studied is held within a narrow sample space 12 between two glass plates 14, 16. An objective lens 18 is positioned in front of the sample, with the gap 13 between the lens and the glass plate 16 normally being filled with oil.

Laser light 19 to illuminate the sample 10 is shone through the edges of the lens, only, the lens refracting this light sufficiently so that when it reaches the forward edge of the glass plate 16, next to the sample, it is totally internally reflected. This internal reflectance causes the sample to be bathed in the light of an evanescent wave within the sample space 12. The fluorescent light emitted by the probes within the sample is collected across the entire area of the lens, and is passed onto other optical elements (not shown) for analysis.

When the light reaching the interface is polarised, the evanescent wave is also polarised. The fluorescence of the molecules of interest will be maximal when the orientation of the absorbing dipole matches the orientation of the polarisation of the evanescent wave. The emitted fluorescence will also be polarised. If the molecules are randomly oriented, no polarisation will be observed for the molecule ensemble, but examination of anisotropy in the time domain provides information about the tumbling rate of the dipole. When single molecules are observed, as is achieved with modern CCD cameras, the orientation of single molecules can be determined. By measuring the angular variation of the intensity of the emitted fluorescence light as a function of the angle of polarisation of the exciting light, the orientation of the dipole can be calculated. Precise calculation of the angle of the fluorescence dipole requires the measurement of a number of polarisation angles.

In TIRF microscope, the interface between the surface of the glass (16) and the sample gap (12) (normally water-filled) itself acts as a polariser. Shining light in a single direction only, so that the incident and reflected waves lie in a single plane, creates a polarised evanescent wave which is more suitable for exciting dipoles by in some directions than in others. One way overcoming this problem is disclosed in S. Wakelin & C. R. Bagshaw, A prism combination for near isotropic fluorescence excitation by total internal reflection, Journal of Microscopy Vol. 209. Pt 2 February 2003, pages 143-148. The device described makes use a complex combination of prisms, acting as beam splitters, to achieve isotropic excitation in three dimensions. Unfortunately, the arrangement described is relatively complex, and it is not applicable for use within a TIRF microscope (Wakelin & Bagshaw illuminate their sample by means of a combination of prisms which is entirely separate from the objective lens used to receive the emitted fluorescent light).

It is a first object of the invention at least to alleviate the difficulties of the prior art.

It is a further object to provide a TIRF microscope in which the user can easily alter the polarisation of the evanescent wave.

According to a first aspect of the present invention there is provided a total internal reflectance microscope comprising an objective lens and a conjugate lens, whereby an illuminating beam incident on the conjugate lens is focussed thereby to a beam spot on the objective lens; the conjugate lens being held in an adjustable mount whereby said lens is movable to cause the beam spot to move around the periphery of the object lens.

Preferably, the microscope is a TIRF microscope.

Where the objective lens and the conjugate lens have parallel optical axes, the mount preferably holds the conjugate lens for rotation about the optical axis of the objective lens/the microscope optical axis. Alternatively, the lens could be selectively angled rather than rotated to cause the beam spot to move around the periphery of the object lens. In such a case, the conjugate lens may be centred on the objective lens optical axis

It will be understood, of course, that in the claims and the description the expression “beam spot” signifies an area of small but non-zero size on the front surface of the objective lens. It should be understood that this spot is not necessarily a focal point of the illuminating beam, but rather the area defined by the intersection of the front surface of the objective lens and the converging cone of the incoming beam of light.

Preferably, the mount is further adjustable to allow the beam spot to be moved radially of the objective lens, as well as circumferentially. In one embodiment, this may be achieved by adjusting the spacing between the optical axis of the objective lens and the parallel optical axis of the conjugate lens.

According to a second aspect of the present invention, there is provided a method of operating a total internal reflectance microscope having an objective lens and a conjugate lens wherein an illuminating beam incident on the conjugate lens is focussed thereby to a beam spot on the objective lens, the method comprising moving the conjugate lens with respect to the objective lens to cause the beam spot to move around the periphery of the object lens.

The method further extends to collecting light from a sample which has been illuminated by the beam, and analysing the collected light as a function of the angular position of the beam spot on the periphery of the object lens. A similar analysis may be carried out as a function of the radial position of the beam spot on the object lens.

The present invention may be carried into practice in a number of ways, and one specific embodiment will now be described, by way of example, with reference to the accompanying drawings, in which:

FIG. 1, illustrates generally the principal of TIRF microscope;

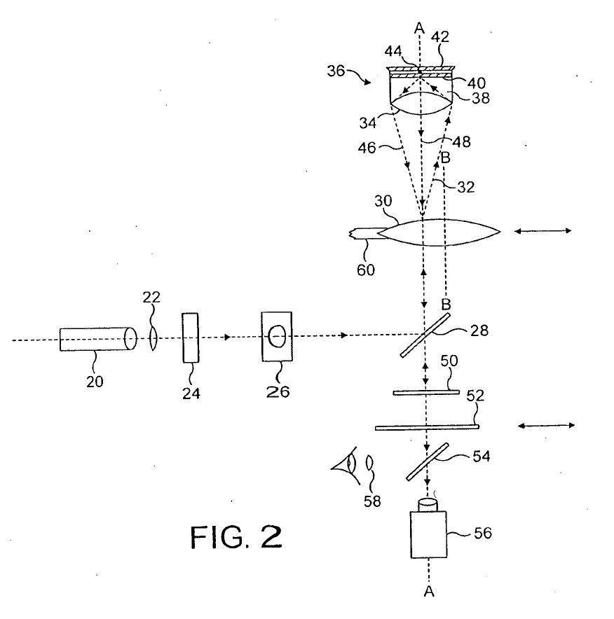

FIG. 2, is a schematic diagram of a TIRF microscope in accordance with an embodiment of the present invention;

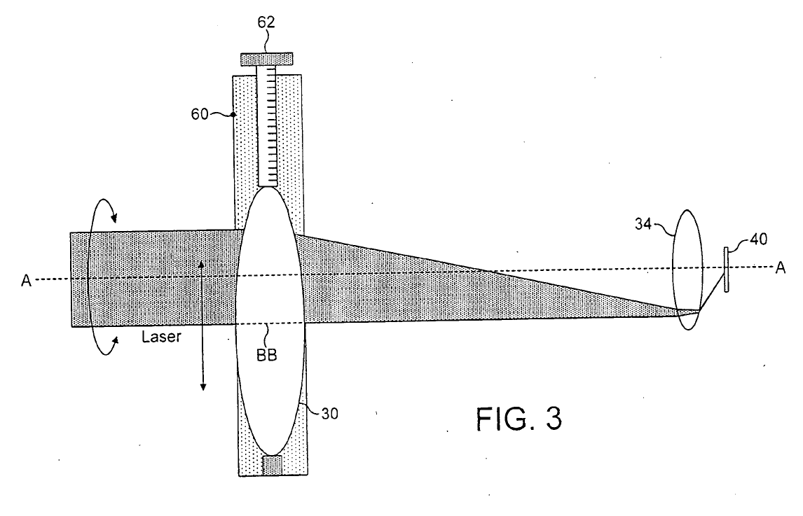

FIG. 3, is a longitudinal section through the conjugate and objective lenses;

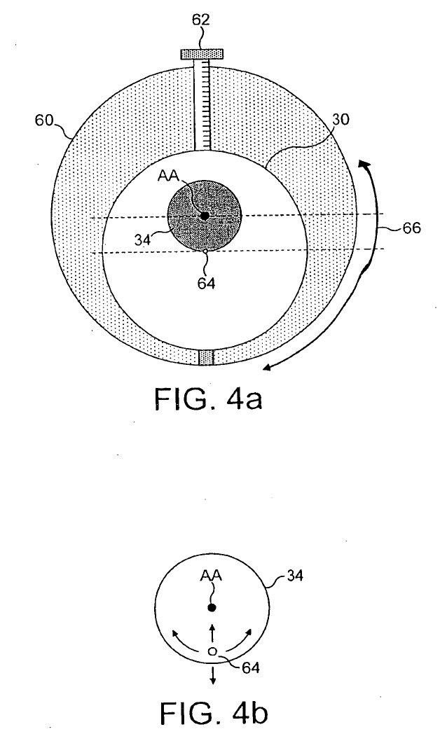

FIG. 4a, shows the way in which the conjugate lens is mounted; and

FIG. 4b, shows the movement of the incident laser light impinging onto the surface of the objective lens.

FIG. 2 is a schematic view of a TIRF microscope according to an embodiment of the present invention. It will be understood, of course, that this Figure is purely schematic, and that it does not represent relative sizes or distances accurately.

As shown in the drawing, a laser 20 generates a beam which passes through a beam expander 22, a beam conditioner (for example a photo elastic modulator) 24 and a stop 26, from which it is directed onto an angled dichroic mirror 28. This reflects the beam toward an off-axis conjugate lens 30. After passing through the lens, the light is refracted at an angle, as shown by reference numeral 32 so as to impinge on the outside edge of an objective lens 34. The light is then refracted through that lens and into a sample holder generally indicated at 36. Within the holder, a sample 44 is held in a water-filled gap between a lower glass plate 40 and an upper glass plate 42. The space 38 between the lower glass plate 40 and the objective lens 34 is oil filled.

Incident light from the edge of the objective lens 34 impinges upon the glass plate 40 at a glancing angle, and is totally internally reflected at the glass/water interface, thereby generating an evanescent wave as previously described in the region of the sample 44. The reflected light passes back through the other edge of the objective lens and either returns back to the conjugate lens 30 or alternatively is blocked by a stop (not shown) in the optical path. The reflected light is of no particular interest in a TIRF arrangement.

Fluorescent light is emitted by the sample in all directions, and part of this emitted light is collected by the objective lens and returns as illustrated by the dotted line 48 (more accurately, within the cone defined by the dotted lines 32, 46) to the conjugate lens. From there it passes back through the dichroic mirror, and through a filter 50, a moveable polarising analyser 52, and a semi silvered mirror 54 to a camera 56. An eye-piece 58 allows the user to view the captured image in real time.

The conjugate lens 30 is provided with an adjustable mount 60 allowing the user manually or automatically to vary the separation between the optical axis the BB of the conjugate lens and the primary optical axis AA of the microscope and of the objective lens 34. The adjustment may be achieved by any convenient means such as for example a lead screw 62, best seen in FIGS. 3 and 4a. By rotating the lead screw, the user can adjust the radial distance between the optical axis of the objective lens and the point at which the laser spot impinges upon it. If the distance is too small, internal reflection will not occur at all, but where the distance is greater than the required minimum total internal reflection will occur, at differing angles of glancing incidence as the conjugate lens is moved.

The conjugate lens mount 60 is also arranged to allow the off-axis conjugate lens 30 to be rotated about an axis of rotation that is co-axial with the main microscope axis AA. FIG. 4a is a view of the conjugate lens and mount looking along the microscope axis AA. Rotation of the mount in the direction of the double headed arrow 66 causes the spot 64 of incident laser light on the edge of the objective lens 34 to travel around the lens circumference. Regardless of the circumferential position of the spot, an evanescent wave at the sample continues to be generated. However, the primary plane of polarisation generated at the interface will rotate with the lens. Thus, by measuring the strength of the emitted fluorescence as a function of the rotational position of the conjugate lens, the user can obtain information about the direction in space of the dipole causing the fluorescence and hence the position of the micro molecule under study. This enables the user to study molecular tumbling in real time.

As shown in FIG. 4a, the conjugate lens mount 60 is arranged as a circle whose centre lies at a point along the microscope axis AA. The circular mount is aligned so that a plane parallel to its upper surface is perpendicular to the microscope axis. The conjugate lens 30 is mounted in the mount and arranged so that the centre of the circular mount does not lie at a point along the optical axis BB of the conjugate lens, i.e. the optical axis of the conjugate lens is off axis with the microscope axis. To enable the circular conjugate lens mount 60 to rotate around its centre, i.e. rotation about an axis of rotation that is co-axial to the microscope axis AA, commercially available radial ball bearings, such as 6210-2RS1 available from SKF, could used around the outer perimeter of the circular lens mount (not shown).

Since, as stated above, the primary plane of polarisation of evanescent waves generated at the glass/water interface will rotate with rotation of the conjugate lens 30, embodiments according to the present invention enable the rotation of the plane of polarisation of the light incident on the sample 44.

In an alternative arrangement (not shown) the device shown may be converted into a conventional microscope acting in bright-field mode simply by positioning an illuminating lamp on the far side of the sample holder 36. This provides the possibility of obtaining a phase contrast image of the sample, at the same time as the TIRF image. Such an arrangement is not possible with the approach of Wakelin & Bagshaw since the location of the prisms would necessarily block an additional source of bright field illumination.

With the apparatus described, the microscope operates in “far-field” mode, that is one obtains a real time view of the whole field all at the same time; the user does not have to scan across the field as is necessary in conventional confocal microscopy.

Another possibility, with reference again to FIG. 2, is to make use of the photo elastic modulator 24, to rotate the plane of polarisation of the incident laser beam, and hence the plane of polarisation of the totally internally reflected exciting beam. It is not believed that as the first approximation this changes the polarisation of the evanescent wave, although there may be second-order effects. If the reflected light 46 is of interest, and is allowed to pass back unimpeded along the optical axis, additional analysis may be carried out using the polarising analyser 52.

1. A total internal reflectance microscope comprising an objective lens and a conjugate lens, whereby an illuminating beam incident on the conjugate lens is focussed thereby to a beam spot on the objective lens; the conjugate lens being held in an adjustable mount whereby said lens is movable to cause the beam spot to move around the periphery of the object lens.

2. A microscope as claimed in claim 1 in which the mount holds the conjugate lens for rotation about an optical axis of the objective lens.

3. A microscope as claimed in claim 1 in which the mount allows the spacing between an optical axis of the objective lens and a parallel optical axis of the conjugate lens to be adjusted.

4. A method of operating a total internal reflectance microscope having an objective lens and a conjugate lens wherein an illuminating beam incident on the conjugate lens is focussed thereby to a beam spot on the objective lens, the method comprising moving the conjugate lens with respect to the objective lens to cause the beam spot to move around the periphery of the object lens.

5. A method as claimed in claim 4 in which the objective lens has a first optical axis and the conjugate lens a second parallel optical axis spaced from the first optical axis, the method comprising rotating the conjugate lens around the first axis.

6. A method as claimed in claim 4 including moving the beam spot in a radical direction of the objection lens.

7. A method as claimed in claim 4 including collecting light from a sample which has been illuminated by the said beam, and analysing the collected lighted as a function of the angular position of the beam spot on the periphery of the object lens.

8. A method as claimed in claim 6 including collecting light from a sample which has been illuminated by the said beam, and analysing the collected light as a function of the radial position of the beam spot on the object lens.

9. A method as claimed in claim 7, in which the said light from the sample is fluorescent light emitted by the sample.

10. A microscope as claimed in claim 2 in which the mount allows the spacing between an optical axis of the objective lens and a parallel optical axis of the conjugate lens to be adjusted.

11. A method as claimed in claim 5 including moving the beam spot in a radical direction of the objection lens.

12. A method as claimed in claim 5 including collecting light from a sample which has been illuminated by the said beam, and analysing the collected lighted as a function of the angular position of the beam spot on the periphery of the object lens.

13. A method as claimed in claim 6 including collecting light from a sample which has been illuminated by the said beam, and analysing the collected lighted as a function of the angular position of the beam spot on the periphery of the object lens.

14. A method as claimed in claim 11 including collecting light from a sample which has been illuminated by the said beam, and analysing the collected lighted as a function of the angular position of the beam spot on the periphery of the object lens.

15. A method as claimed in claim 7 including collecting light from a sample which has been illuminated by the said beam, and analysing the collected light as a function of the radial position of the beam spot on the object lens.

16. A method as claimed in claim 11 including collecting light from a sample which has been illuminated by the said beam, and analysing the collected light as a function of the radial position of the beam spot on the object lens.

17. A method as claimed in claim 12 including collecting light from a sample which has been illuminated by the said beam, and analysing the collected light as a function of the radial position of the beam spot on the object lens.

18. A method as claimed in claim 13 including collecting light from a sample which has been illuminated by the said beam, and analysing the collected light as a function of the radial position of the beam spot on the object lens.

19. A method as claimed in claim 14 including collecting light from a sample which has been illuminated by the said beam, and analysing the collected light as a function of the radial position of the beam spot on the object lens.

20. A method as claimed in claim 8 in which the said light from the sample is fluorescent light emitted by the sample.

21. A method as claimed in claim 12 in which the said light from the sample is fluorescent light emitted by the sample.

22. A method as claimed in claim 13 in which the said light from the sample is fluorescent light emitted by the sample.

23. A method as claimed in claim 14 in which the said light from the sample is fluorescent light emitted by the sample.

24. A method as claimed in claim 15 in which the said light from the sample is fluorescent light emitted by the sample.

25. A method as claimed in claim 16 in which the said light from the sample is fluorescent light emitted by the sample.

26. A method as claimed in claim 17 in which the said light from the sample is fluorescent light emitted by the sample.

27. A method as claimed in claim 18 in which the said light from the sample is fluorescent light emitted by the sample.

28. A method as claimed in claim 19 in which the said light from the sample is fluorescent light emitted by the sample.
